(19) United States
(12) Patent Application Publication
(10) Pub. No.: US 2010/0299164 A1
(43) Pub. Date: Nov. 25, 2010

(54) Human Capital Management Computer System and Method

(76) Inventor: Jean-Marc Satta, Paris (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/085,417

(22) PCT Filed: Feb. 8, 2008
(86) PCT No.: PCT/IB2008/051273

§ 371 Date: Jul. 19, 2010

(51) Int. Cl. G06Q 10/00

(52) U.S. Cl. 705/7

(57) ABSTRACT

The invention relates to a computer system, and associated operating method, for determining a training program to be taken by an individual to reach desired skills, comprising:
a capabilities database;
a training programs database wherein a training program is related to one or more capability development paths, each capability development path enabling a capability to improve from a first level to a second level;
means for associating to each of the capabilities stored in the capabilities database a rated capability couple composed of a current level rated as a function of an individual's current profile and of a desired level rated as a function of an individual's desired profile;
processing means configured so as to:
   extract, for each capability, from the training programs database, those training programs which are related to a capacity development path enabling said capability to improve from its current level to its desired level; and
   sort the training programs which have been extracted for all of the capabilities, wherein the sorting comprises for each extracted training program the calculation of a static weight as a function of the ratio between the number of times said program has been extracted and the number of capability development paths to which said program is related to in the training programs database.

### BACKGROUND OF THE INVENTION

The invention relates generally to a computer system and a computer-implemented method for determining a training program to be taken by an individual to reach desired skills.

More precisely, the invention provides systems and methods for automatically determining, during the course of an examination process of the skills of an individual, of a training program to be taken by the individual to reach desired skills. The invention also provides for automatically selecting individuals which are the best suited for a desired profile.

In order to be competitive, companies are continuously training its employees to learn necessary skills and to update its workforce about current procedures.

For this purpose, employees are regularly evaluated so as to assess their current skills. Further to such evaluation, it is usually determined empirically that an employee could improve particular skills by taking a particular training program.

However, such a process is somewhat complex and time-consuming. It further relies mainly upon the experience of the human resources department staff, and may consequently prove not to be competitive in terms of cost or efficiency.

For instance, in a five hundred employees company, skills catalog is about five hundred lines, training program catalog is about one thousand lines, which means five hundred thousand possibilities. If processed manually, people in charge of evaluation and training program generation thus have to manage five hundred thousand possibilities, which of course can not be contemplated.

Consequently, in a classical human resources management, mobility of the individuals (internal or external to a company) is not encouraged and such management is typically restricted to the identification of only those individuals which already have experience in a particular activity, but does not take into account the capacity of an individual, with his capabilities and development potential, to practice this activity.

### SUMMARY OF THE INVENTION

In order to solve the above mentioned drawbacks, the invention proposes a computer system for determining a training program to be taken by an individual to reach desired skills, comprising:
a capabilities database;
a training programs database wherein a training program is related to one or more capability development paths, each capability development path enabling a capability to improve from a first level to a second level;
means for associating to each of the capabilities stored in the capabilities database a rated capability couple composed of a current level rated as a function of an individual's current profile and of a desired level rated as a function of an individual's desired profile;
processing means configured so as to:
   extract, for each capability, from the training programs database, those training programs which are related to a capacity development path enabling said capability to improve from its current level to its desired level; and
   sort the training programs which have been extracted for all of the capabilities, wherein the sorting comprises for each extracted training program the calculation of a static weight as a function of the ratio between the number of times said program has been extracted and the number of capability development paths to which said program is related to in the training programs database.

Other preferred but non limitative aspects of this system are as follows.
the sorting performed by the processing means also comprises for each extracted training program the calculation of at least one of the following weights: cost weight, time budget weight, duration weight, feasibility weight, qualitative weight, performance weight and interest weight;
the processing means are further configured to associate a modifiable constant to each weight, so as to define the importance of each weight in the training programs sorting;
the training program databases further contains for each training program information on at least one of the following items: feasibility, cost, time budget and duration of the training program, and wherein the processing means are further configured to associate to each sorted training programs said at least one item;
the computer further comprises interfacing means so as to allow communication with a remote client through a computer network.

According to a second aspect, the invention proposes a method for determining a training program to be taken by an individual to reach desired skills, comprising the steps of
extracting, for each capability in a capabilities database, from a training programs database wherein a training program is related to one or more capability development paths each enabling a capability to improve from a first level to a second level, those training programs which are related to a capacity development path enabling said capability to improve from a current level rated in the capabilities database as a function of an individual's current profile to a desired level rated in the capabilities database as a function of an individual's desired profile;
sorting the training programs which have been extracted for all of the capabilities, wherein the sorting comprises for each extracted training program the calculation of a static weight as a function of the ratio between the number of capability development paths to which said program is related to in the training programs database and the number of times said program has been extracted.

According to specific embodiments of the invention, the method can be implemented for a plurality of individuals so as to determine a training program to be taken by each individual to reach the skills necessary for the jobs, and wherein the individuals are ranked as a function of the at least one item associated to their training program.

### BRIEF DESCRIPTION OF THE DRAWINGS

Other characteristics, purposes and advantages of the invention will appear to the reading of the following detailed description, with respect to the annexed drawings, given as non restrictive examples, in which:

FIG. 1 is a diagram showing a possible embodiment of the computer system of the invention which exchanges human capital management information with a client trough a computer network;

FIG. 2 shows examples of capabilities which are relevant for a Senior Technology Manager;

FIG. 3 is a flow chart diagram showing the different steps for deriving a training program when making use of the system of FIG. 1;

FIG. 4 shows an example of the association of cost, budget, duration and feasibility information to several training programs.

### DETAILED DESCRIPTION OF THE PREFERRED EMBODIMENTS

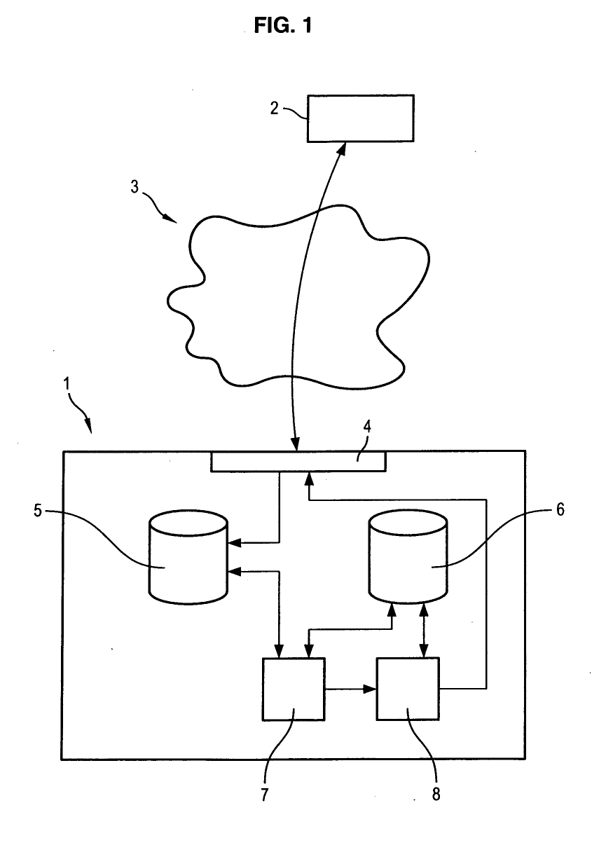

FIG. 1 shows an embodiment of a computer system 1 for determining a training program to be taken by an individual to reach desired skills.

The computer system 1 can typically communicate with a remote client 2 (such as a human resources datawarehouse, or a personal computer) through a computer network 3, such as the Internet

For this purpose, the computer system 1 comprises interface means 4, for instance of the type which implements a secure Application Service Provider (ASP) web portal.

The computer system 1 further comprises a capabilities database 5 which has fields and sub-fields related to different capabilities of individuals.

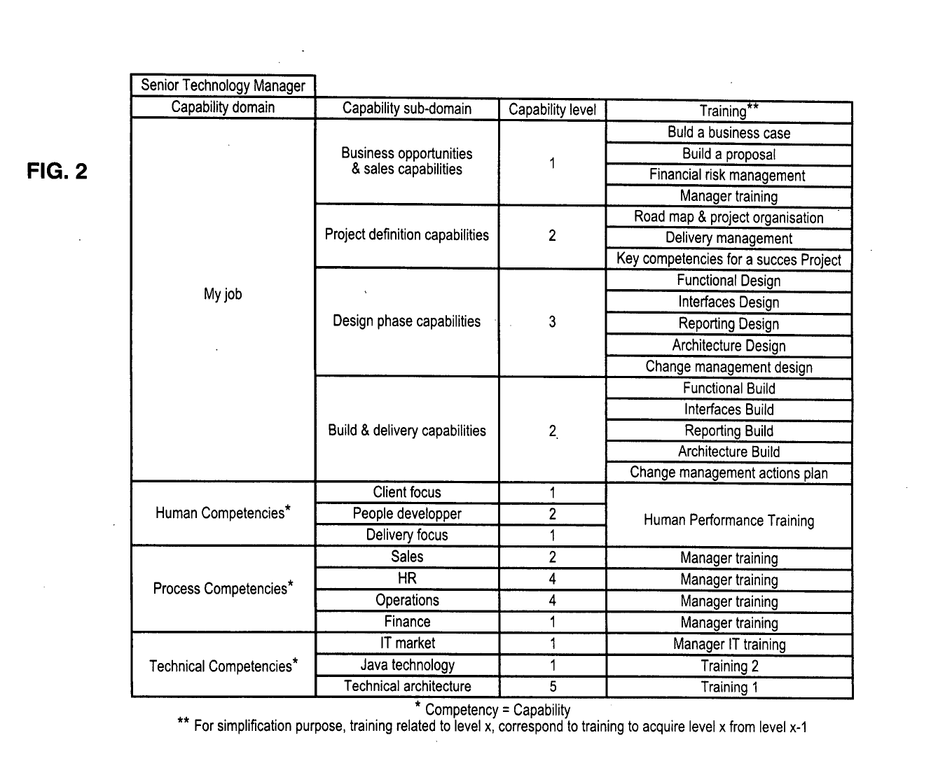

Examples of an individual's capabilities for a Senior Technology Manager are shown on FIG. 2.

A profile is defined by a capability domain, a capability sub-domain and a level required. Level required allows qualifying and differentiating the level of expertise, knowledge.

Each training program allows acquiring one or several capability sub-domains. One training program can be used for one or several capability sub-domains.

Levels can be associated with each particular capability in the capabilities database 5, so as to rate each particular capability as a function of the current practice level of an individual with respect to this capability, and as a function of a desired practice level.

In order to associate levels with each capability, prior evaluations are typically carried out in the course of which an individual's profile is determined. The individual's current profile (its set of capabilities) can be derived from personal interviews of the individual with its superiors, and/or from information given by the individual itself.

The individual's current profile is translated into a set of rates, with a rate being given to each capability in the database capabilities.

A desired profile is also defined, which can correspond to an existing job within the company, or correspond to a desired profile the individual is invited to reach. The desired profile is also translated into a set of rates.

These rates can for instance typically be indicated by the client 2 to the computer system 1, for instance by filling a web-based form.

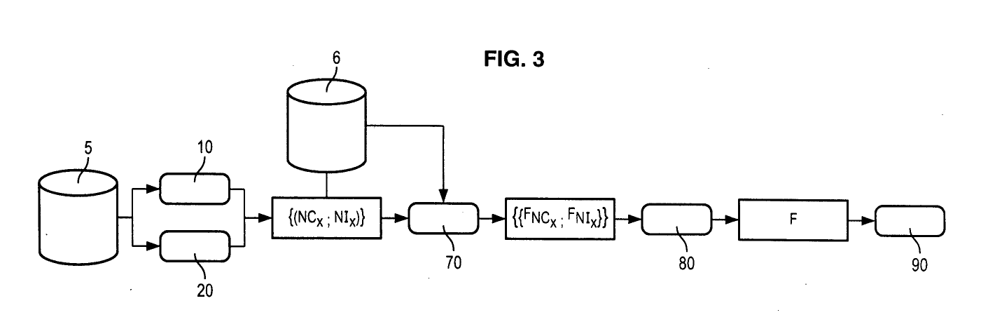

In the flow chart diagram of FIG. 3, box 10 illustrates the evaluation of an individual, and the association to each capability in the capabilities database 5 of a rate taking into account the current practice level of the individual. Box 20 illustrates the setting of a desired profile, whereby a rate is associated to each capability in the capabilities database 5 as a function of said desired profile.

The computer system 1 further comprises a training programs database 6 wherein a training program is related to one or more capability development paths, each capability development path enabling a capability to improve from a first level to a second level.

Each of these capability development paths thus forms a capability couple composed of the first and second levels, hereafter called a referent capability couple.

The computer system 1 further comprises processing means 7 configured for extracting, for each rated capability in the capabilities database 5, from the training programs database 6, those training programs which are related to a capacity development path enabling said capability to improve from its current level to its desired level.

Relation between a rated capability'couple and the training programs is indeed a (1,n) relation, i.e. a capacity development path enabling a capacity to improve from a level A to a level B can indeed be related to a plurality of training programs.

Let's consider (NCx; NIx) a rated capability couple relating to a capacity development path between a current level (NIx) and a desired level (NCx) for capability Cx.

The relation between the rated capability couple and the training programs can thus be represented as (NCx; NIx)->{F_{(NCx; NIx)}}, where F_{(NCx; NIx)} is a training program from the training programs database 6 which is related to a capacity development path enabling capability Cx to improve from level (NIx) to level (NCx).

As shown on FIG. 3, further to the evaluation of the individual current profile and of the desired profile, a set of rated capability couples is defined according to (NCc; NIc)={(NCx; NIx)} with NCc designating the current profile and NIc the desired profile.

For the purpose of extraction, a rated capability couple is compared to the referent capability couples to identify those referent capability couples which enable the capability to improve from its rated current level to its rated desired level. Those training programs which are related to the said identified referent capability couples are then extracted.

Following extraction (this being represented as box 70 on FIG. 3), a set of training programs is obtained which consists of the training programs which have been extracted for all of the capabilities.

This set of extracted training programs is designated as {{F_{(NCx; NIx)}}} on FIG. 3.

In such set, a particular training formation may have multiple occurrences, as it has been extracted for several rated capability couples.

The computer system 1 further comprises processing means 8 configured for sorting the training programs which have been extracted for all of the capabilities, wherein the sorting comprises for each extracted training program the calculation of a static weight PSP as a function of the ratio between the number of times said program has been extracted (that is the number of occurrences of the training program in said set of extracted training programs) and the number of capability development paths to which said program is related to in the training programs database. Such sorting is represented as box 80 on FIG. 3.

The static weight of a training program can be expressed as PSP=C_{PSP}*var_{PSP}, where C_{PSP} is a constant and var_{PSP} is the above mentioned ratio.

The sorting according to the invention allows obtaining a ranking of the extracted training programs.

According to possible embodiments of the invention, the sorting of extracted training programs can further comprises the calculation of one or another of the following weights, taken in isolation or in combination.

According a preferred embodiment of the invention, a cost, a time budget, a duration and a feasibility are associated to each training program.

An extracted training program can thus be weighted by the following weights:
Cost weight PC
PC=C_{PC}*var_{PC}, where C_{PC} is a constant and var_{PC}=(highest training program cost)/(cost of the training program)
Duration weight PD
PD=C_{PD}*var_{PD} where C_{PD} is a constant and var_{PD}=(highest training program duration)/(duration of the training program)
Time budget weight PT
PT=C_{PT}*var_{PT}, where C_{PT} is a constant and var_{PT}=(highest training program time budget)/(time budget of the training program)
Feasibility weight PFa
PFa=C_{PFa}*var_{PFa}, where C_{PFa} is a constant and var_{PFa}=(training program feasibility).

A qualitative weight PQ can also be calculated which relates to evaluations of the training program made by individuals that have taken this training program. Such evaluations can be marks ranking from 0 to “maximal mark”, and the qualitative weight PQ can be expressed as PQ=C_{PQ}*var_{PQ}, where C_{PQ} is a constant and var_{PQ}=[1/(number of times the training program has been evaluated)]*Σ_{number of times the training program has been evaluated}(Given marks/Maximal marks).

A performance weight PE can also be calculated which relates to the efficiency of a training program. This performance weight PE can be calculated as the ratio between the number of individuals which have taken the training program and acquired the desired capability (as for instance recorded during the evaluation of the individual's skills) and the total number of individuals which have taken the training program. This ratio can further be weighted by the acquisition duration of the capability (compared to the forecasted acquisition duration). The performance weight PE can thus be expressed as PE=C_{PE}*var_{PE}, where C_{PE} is a constant and var_{PE}=Σ_{number of occurrences of the acquisition of the capability}(Forecasted acquisition duration/Acquisition Duration)/total number of individuals which have taken the training program.

An interest weight PI can also be calculated which relates to the number of times an extracted training program has been elected, and consequently to the taking of the training program as a function of the similitude between evaluated profiles. The interest weight can be expressed as PI=C_{PI}*var_{PI}, where C_{PI} is a constant and var_{PI}=Σ_{number of times the training program has been elected}(Number of mutual capabilities/Total number of capabilities)/Number of times the training program has been elected.

Let's write Px any one of the hereabove defined weights. For each weight Px, Px=C_{Px}*var_{Px}, where C_{Px} is a constant and var_{Px} is a variable.

A total weight P of an extracted training program can be defined by the baric centre (weighted mean) of the variables:

P=baric centre(Px)=Σ(CPx*varPx)/Σ(CPx).

P=baric center(PSP, PFa, PC, PD, PT, PQ, PE, PI)

Each constant C_{PX} is defined in accordance with the desired importance that is to be given to the weight Pₓ in the calculation of the global weight P. These constants can therefore be modified depending upon the context.

Each constant C_{PX} thus varies between 0 and 1 as a function of the context (objectives and constraints of the company).

The static weight of a training plan (PSP) is directly based on the data and structure of capabilities and training programs databases. Thus, it is an objective weight and associated constant is generally set to 1.

Constants settings mainly depend on the business context and maturity level of company in terms of human capital development.

The constants are therefore set according to the Business Model and the Training Strategy of the company using the system and method according to the invention.

For instance, if growth is the main focus of the company, PD, PQ and PE weights will be over-weighted while PT and PC weights will be under-weighted.

On the contrary, if cost reduction is the main focus, PT and PC weights will be over-weighted while PD, PQ and PE weights will be under-weighted.

Feasibility weight PFa is based on the strategy of company in terms of people development. If the company strategy relies on external recruitment, PFa is then over-weighted. On the contrary, if its strategy is based on internal people development, PFa will be under-weighted.

The interest weight PI is based on behaviour of people in charge of evaluation and training program generation. For a company maintaining its human capital management strategy, PI will be over-weighted. On the contrary, for a company deciding to change its strategy in terms of human capital management, PI will be under-weighted.

The weighting allows for a sorting of the extracted training programs, with ideal training programs (referenced as F on FIG. 3) corresponding to the training programs having the highest total weights P.

As already discussed above, a cost, a time budget, a duration and a feasibility are associated to each training program. These information can help in selecting amongst the ideal training programs. Such selection is represented as box 90 on FIG. 3.

Indeed, amongst for instance the ten highest weight extracted training programs, some may be associated to a high cost, budget, duration or low feasibility, so that—although they have a better rank—they may be considered as less preferable.

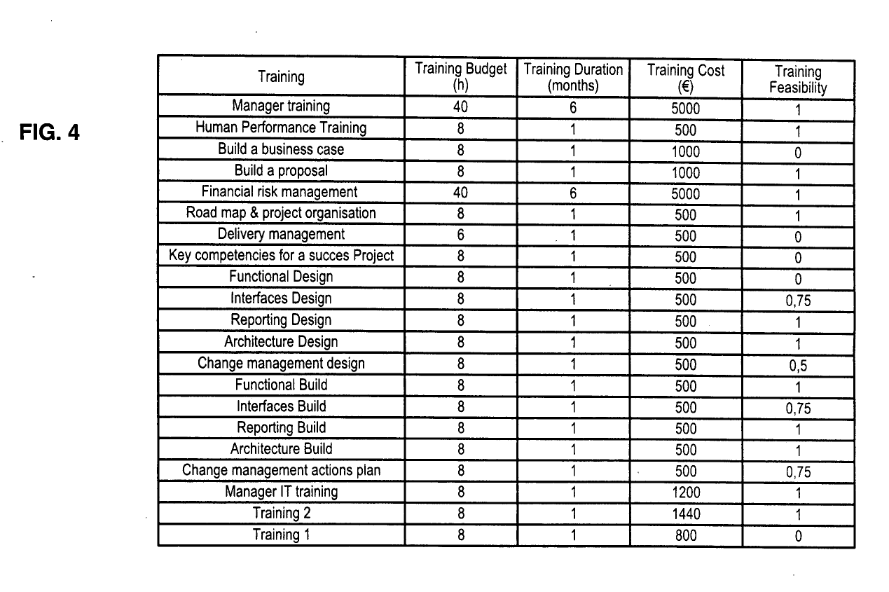

FIG. 4 shows an example of such association of cost, budget, duration and feasibility information to several training programs.

In the above example, person in charge of assessment and training program generation of individual can decide to remove “Build a Business Case Training” (because of its low feasibility) and “Financial Risk Management” (because of its high Budget and cost).

One possible application of the invention is the generation, when evaluating the current skills of an employee, of an individual training program that the employee should take. In this application, the employee is evaluated for each of the capabilities he currently exercised. For each of these exercised capabilities, an objective is set. The rated capability couples are consequently obtained, from which training programs can be extracted from the training program databases and sorted so as to elect the most relevant.

The definitive choice is thereafter made to elect a single training program, on the basis of the feasibility of each relevant training program, and of the cost, time budget, duration constraints associated to each relevant training program. This definitive choice is further stored in order to be used when calculating the interest weight PI.

Another possible application of the invention is the automation of identification of individuals already present within a company (internal mobility) or of individual currently not employed by the company (external mobility) that would be the more suitable for a particular job. In such case, the desired skills are set for the particular job, and a training program is defined for each of the employees of the company or each the applicants to determine how they could acquire the skills necessary to the job. A mark is then attributed to the training program which reflects its feasibility. A sorting of the individuals can therefore be obtained.

In the context of such application, it is further possible to apply constraints or discriminatory criteria so as to limit the number of results. Typical constraints are cost constraints, time budget constraints or training duration constraints. Discriminatory criteria correspond for instance to a capability level that an individual has to currently possess.

Another possible application of the invention relates to the implementation of a succession plan whereby individuals are identified that could be used so as to respond to future needs of the company. In this application, risk profiles (such as those corresponding to the corporate executives) are determined and employees are ranked in accordance with the feasibility and constraints of the training program that could help the employee gaining the skills necessary for the risk profile.

The invention adds value for the organization which makes use of it. In particular, the invention helps in reducing the people time management, in improving capabilities and productivity, in reducing training costs, and allows for people development forecast and for allow human capital management strategic decision in real time.

1. A computer system for determining a training program to be taken by an individual to reach desired skills, comprising:
a capabilities database;
a training programs database wherein a training program is related to one or more capability development paths, each capability development path enabling a capability to improve from a first level to a second level;
means for associating to each of the capabilities stored in the capabilities database a rated capability couple composed of a current level rated as a function of an individual's current profile and of a desired level rated as a function of an individual's desired profile;
processing means configured so as to:
extract, for each capability, from the training programs database, those training programs which are related to a capacity development path enabling said capability to improve from its current level to its desired level; and
sort the training programs which have been extracted for all of the capabilities, wherein the sorting comprises for each extracted training program the calculation of a static weight as a function of the ratio between the number of times said program has been extracted and the number of capability development paths to which said program is related to in the training programs database.

2. The computer system of claim 1, wherein the sorting performed by the processing means also comprises for each extracted training program the calculation of at least one of the following weights: cost weight, time budget weight, duration weight, feasibility weight, qualitative weight, performance weight and interest weight.

3. The computer system of claim 2, wherein the processing means are further configured to associate a modifiable constant to each weight, so as to define the importance of each weight in the training programs sorting.

4. The computer of claim 1, wherein the training program databases further contains for each training program information on at least one of the following items: feasibility, cost, time budget and duration of the training program, and wherein the processing means are further configured to associate to each sorted training programs said at least one item.

5. The computer system of claim 1, further comprising interfacing means so as to allow communication with a remote client through a computer network.

6. A method for determining a training program to be taken by an individual to reach desired skills, comprising the steps of
extracting, for each capability in a capabilities database, from a training programs database wherein a training program is related to one or more capability development paths each enabling a capability to improve from a first level to a second level, those training programs which are related to a capacity development path enabling said capability to improve from a current level rated in the capabilities database as a function of an individual's current profile to a desired level rated in the capabilities database as a function of an individual's desired profile;
sorting the training programs which have been extracted for all of the capabilities, wherein the sorting comprises for each extracted training program the calculation of a static weight as a function of the ratio between the number of capability development paths to which said program is related to in the training programs database and the number of times said program has been extracted.

7. The method of claim 6, further comprising the prior step of rating, by a remote client, capabilities of the capabilities database as a function of the individual's current profile and the individual's desired profile.

8. The method of claim 6, further comprising the calculation of at least one of the following weights: cost weight, time budget weight, duration weight, feasibility weight, qualitative weight, performance weight and interest weight.

9. The method of claim 8, wherein the importance of each weight can be modified.

10. The method of claim 8, further comprising associating to each sorted training program information on at least one of the following items: feasibility, cost, time budget and duration of the training program.

11. Method for selecting an individual for a job, wherein the method of claim 10 is implemented for a plurality of individuals so as to determine a training program to be taken by each individual to reach the skills necessary for the jobs, and wherein the individuals are ranked as a function of the at least one item associated to their training program.
